(19) United States
(12) Patent Application Publication
(10) Pub. No.: US 2024/0222667 A1
(43) Pub. Date: Jul. 4, 2024

(54) FUEL CELL SYSTEM AND OPERATING METHOD FOR OPERATING A FUEL CELL SYSTEM

(71) Applicant: Robert Bosch GmbH, Stuttgart (DE)

(72) Inventors: Helerson Kemmer, Vaihingen (DE); Juergen Gross, Stuttgart (DE); Kai Weeber, Heimsheim (DE)

(21) Appl. No.: 18/562,970

(22) PCT Filed: May 24, 2022
(86) PCT No.: PCT/EP2022/063996

§ 371 Date: Nov. 21, 2023

(30) Foreign Application Priority Data
May 26, 2021 (DE) 10 2021 205 342.4

(51) Int. Cl. H01M 8/04664; H01M 8/04537

(52) U.S. Cl. CPC H01M 8/04679; H01M 8/04552; H01M 8/04619; H01M 2250/20

(57) ABSTRACT

The invention relates to a fuel cell system (100) for providing electric energy, said fuel system having a plurality of fuel cell stacks (103, 105, 107), comprising a first fuel cell stack (103) and at least one other fuel cell stack (105, 107), and a monitoring device (109) for monitoring the plurality of fuel cell stacks (103, 105, 107).

The monitoring device (109) is configured so as to select the fuel cell stack (103, 105, 107) of the plurality of fuel cell stacks (103, 105, 107) with the lowest service life indicator among the service life indicators of each fuel cell stack (103, 105, 107) of the plurality of fuel cell stacks (103, 105, 107) in order to provide electric energy in response to an output requirement and so as to operate the selected fuel cell stack (103, 105, 107) in a specific operating range, and if the output requirement is not satisfied by the specified operating range of the selected fuel cell stack (103, 105, 107), the monitoring device is configured so as to operate at least one additional fuel cell stack (103, 105, 107) of the plurality of fuel cell stacks (103, 105, 107) in the specified operating range, wherein the specified operating range lies between the minimum output and the full output of the respective fuel cell stack (103, 105, 107).

### BACKGROUND OF THE INVENTION

Fuel cell systems use oxygen to convert hydrogen into electrical energy, generating waste heat and water. For this purpose, fuel cell systems comprise at least one fuel cell stack consisting of a number of fuel cells with an anode that is supplied with hydrogen, a cathode that is supplied with air and a polymer electrolyte membrane arranged between the anode and cathode.

Depending on the output demanded or delivered, the fuel cells in a fuel cell system are subjected to different levels of stress and age correspondingly differently.

### SUMMARY OF THE INVENTION

In the context of the invention presented, a fuel cell system and an operating method with the features of the respective independent patent claims are presented. Further features and details of the invention will emerge from the respective dependent claims, the description, and the drawings. Features and details that are described in connection with the fuel cell system according to the invention naturally also apply in connection with the operating method according to the invention and vice versa, so that the disclosure always refers or can refer to the individual aspects of the invention reciprocally.

The invention presented serves to enable robust operation of a fuel cell system. In particular, the invention presented here is used to balance the aging process of several fuel cell stacks of a fuel cell system and, as a result, to maximize the lifetime of the fuel cell system.

A fuel cell system for the provision of electrical energy is thus presented. The fuel cell system comprises a plurality of fuel cell stacks including a first fuel cell stack and at least one further fuel cell stack, a monitoring device for monitoring the plurality of fuel cell stacks. The monitoring device is configured to select, in response to an output requirement, the fuel cell stack from the plurality of fuel cell stacks for providing electrical power whose service life indicator is the lowest among respective service life indicators of respective fuel cell stacks of the plurality of fuel cell stacks. The monitoring device is further configured to operate the selected fuel cell stack in a predetermined operating range and, in the event that the output requirement cannot be met with the predetermined operating range of the selected fuel cell stack, to operate at least one further fuel cell stack of the plurality of fuel cell stacks in the predetermined operating range, wherein the predetermined operating range is between a minimum output and a full output of the respective fuel cell stack.

In the context of the invention presented here, the minimum output of a fuel cell stack is to be understood as an output range in which the fuel cell stack is operated with a very high voltage or an overvoltage of, for example, more than 850 millivolts per fuel cell.

In the context of the invention presented here, full output of a fuel cell stack is to be understood as an output range in which the fuel cell stack operates at a reduced voltage of, for example, a voltage that is lower than a predetermined operating range or normal range. 600 millivolts to 650 millivolts.

In the context of the invention presented, a service life indicator is to be understood as a value that quantifies a state of a fuel cell stack, such as, for example, an operational performance, an operating time, a maintenance interval or a time elapsed since a last maintenance, a maximum output that can be generated by the fuel cell stack and/or a state of wear.

In the context of the present invention, an output requirement is to be understood as a value of an output to be provided, which is specified by a consumer, such as an engine monitoring device, to the fuel cell system presented. In particular, an output requirement can be determined via a function of a movement of an accelerator pedal of a vehicle.

High voltages at minimum output and full output can lead to increased signs of ageing in the respective fuel cells of a fuel cell stack. In order to minimize such signs of ageing, the fuel cell system presented is based on a plurality of fuel cell stacks, which are monitored together by a monitoring device. The various fuel cell stacks are controlled in such a way that they are operated as long or as often as possible in the specified operating range and correspondingly as little or as briefly as possible in other operating states, in particular at minimum output or full output.

In order to maximize an operating time of respective fuel cell stacks of the presented fuel cell system in the predetermined operating state and thereby achieve uniform aging, in particular a uniform operating time among the respective fuel cell stacks, the monitoring device of the presented fuel cell system is configured to always select that fuel cell stack for providing a required output from a plurality of fuel cell stacks whose service life indicator is the lowest among respective service life indicators of respective fuel cell stacks of the plurality of fuel cell stacks. This means that more heavily loaded fuel cell stacks are activated less often than less heavily loaded ones. Accordingly, fuel cell stacks whose service life indicator points to a long remaining operating time are activated more frequently or preferentially compared to fuel cell stacks whose service life indicator points to a short or shorter service life.

The fuel cell system presented enables any scaling, i.e. interconnection of any number of fuel cell stacks, so that high outputs in particular can be provided by a plurality of small or relatively weak fuel cell stacks.

It can be provided that the specified operating range corresponds to a cell voltage between 900 millivolts and 600 millivolts, in particular between 850 millivolts and 650 millivolts.

Since cell voltages in the range of 850 millivolts and more or in the range of 600 millivolts and less result in a particularly high load and correspondingly strong ageing of fuel cells, a range between 900 millivolts and 600 millivolts, in particular between 850 millivolts and 650 millivolts, is particularly advantageous as a predetermined operating range for minimizing signs of ageing or maximizing the lifetime of the fuel cell system presented.

It can further be provided that, in the event that the output requirement cannot be met with the predetermined operating range of the selected fuel cell stack, the monitoring device is configured to switch, in addition to the selected fuel cell stack, that fuel cell stack of the plurality of fuel cell stacks into the predetermined operating range whose service life indicator is the lowest among respective service life indicators of respective further fuel cell stacks of the plurality of fuel cell stacks.

By adding a further activated fuel cell stack to a first activated fuel cell stack even before the first fuel cell stack is operated in an operating range outside the specified operating range, increased load or increased ageing of both the first fuel cell stack and the further fuel cell stack can be prevented, since neither fuel cell stack is operated at full output or at minimum output.

It can also be provided that, in the event that the output requirement is reduced such that it can be met with less than the number of fuel cell stacks currently operating in the specified operating range, the monitoring device is configured to deactivate the fuel cell stack whose service life indicator is the highest among the activated fuel cell stacks.

Prioritized deactivation of fuel cell stacks with the highest service life indicator minimizes the operating time or load of these fuel cell stacks and maximizes the operating time or load of fuel cell stacks with lower service life indicators, so that the various fuel cell stacks of the fuel cell system presented age evenly.

It can also be provided that, in the event that the output requirement cannot be met by operating all the fuel cell stacks of the plurality of fuel cell stacks in the specified operating range, the monitoring device is configured to switch the fuel cell stack whose service life indicator is lowest to an increased output range.

In order to protect those fuel cell stacks that already have a high service life indicator value in the event of a particularly high load on the fuel cell system presented and, as a result, to maximize the lifetime of the fuel cell system, it has proven to be advantageous to prioritize those fuel cell stacks with an increased load or to operate them in an operating range that lies outside the specified operating range whose service life indicator is the lowest.

It can also be provided that, in the event that the output requirement cannot be met by operating all the fuel cell stacks of the plurality of fuel cell stacks in the predetermined operating range, the monitoring device is configured to switch at least some of the respective activated fuel cell stacks to an overload operating range for a predetermined duration, in which more output is generated than in the predetermined operating range, and only after the predetermined duration to switch the fuel cell stack whose service life indicator is lowest to an increased output range.

To avoid high-frequency activation and deactivation of additional fuel cell stacks, a switching time can be specified during which additional fuel cell stacks are not activated despite increased output requirement. If the output requirement is reduced within the switching time, there is no need to activate a further fuel cell stack and the associated increased load due to a start process and a shutdown process.

In a second aspect, the presented invention relates to an operating method for operating a fuel cell system comprising a plurality of fuel cell stacks. The operating method comprises a selection step for selecting a respective fuel cell stack to be operated in a predetermined operating range from the plurality of fuel cell stacks in response to an output requirement, wherein the fuel cell stack whose service life indicator is lowest among respective service life indicators of respective fuel cell stacks of the plurality of fuel cell stacks is selected, a setting step for setting the selected fuel cell stack to the predetermined operating range, and an expansion step for expanding the selected fuel cell stack by at least one further fuel cell stack from the plurality of fuel cell stacks in the event that an output provided by the selected fuel cell stack in the predetermined operating range does not fulfill the output requirement, wherein the fuel cell stack whose service life indicator is the lowest among respective service life indicators of respective fuel cell stacks of the further fuel cell stacks is selected for expansion from among the further fuel cell stacks.

The operating method presented serves in particular to operate a possible configuration of the fuel cell system presented.

It can be provided that the operating method comprises a deactivation step in which, in the event that the output requirement is reduced such that it can be met with less than a number of fuel cell stacks currently operating in the specified operating range, the fuel cell stack whose service life indicator is highest among the activated fuel cell stacks is deactivated.

In a third aspect, the invention presented relates to a means of transportation with a possible configuration of the fuel cell system presented.

The vehicle presented can be, for example, a passenger car, a truck, a bus, a ship, a train or an airplane.

Due to the plurality of fuel cell stacks in the fuel cell system presented, the fuel cell system presented is particularly suitable for providing high output and, as a result, for use in large or heavy means of transportation.

The comparative activation of respective fuel cell stacks of the fuel cell system presented according to the invention can maximize maintenance intervals and minimize failures.

### BRIEF DESCRIPTION OF THE DRAWINGS

Further advantages, features, and details of the invention will emerge from the following description, in which embodiment examples of the invention are described in detail with reference to the drawings. In this context, the features specified in the claims and in the description can each be essential to the invention, individually or in any combination.

In the drawings:

FIG. 1 shows a possible configuration of the presented fuel cell system in a possible configuration of the presented means of transportation,

FIG. 2 shows a schematic representation of operating areas of a fuel cell stack of the fuel cell system presented,

FIG. 3 shows a schematic representation of an operation of the fuel cell system presented in a first time range,

FIG. 4 shows the fuel cell system according to FIG. 3 in a second, later time range,

FIG. 5 shows a possible configuration of the operating method presented,

FIG. 6 shows an optional aspect of the operating method presented.

### DETAILED DESCRIPTION

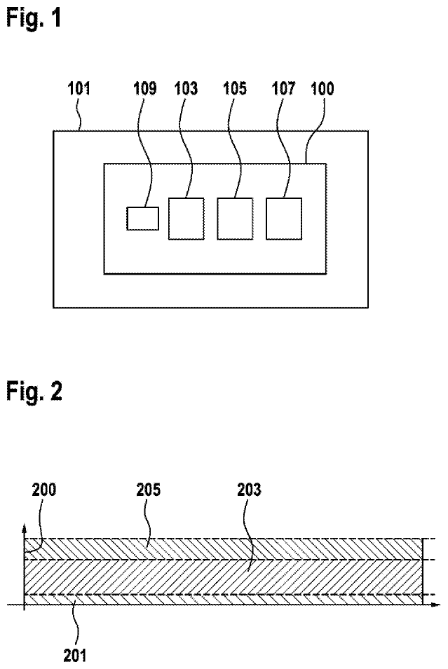

FIG. 1 shows a fuel cell system 100. The fuel cell system 100 is part of a means of transportation 101 in the form of a truck and comprises a first fuel cell stack 103, a second fuel cell stack 105, a third fuel cell stack 107 and a monitoring device 109, such as, for example, a control device or any other form of programmable circuitry.

For example, the first fuel cell stack 103 shows a service life indicator of 100 operating hours, the second fuel cell stack 105 shows a service life indicator of 110 operating hours and the third service life indicator 107 shows 130 operating hours.

In response to an output requirement specified by a driver of the means of transportation 101, the monitoring device 109 selects for activation the fuel cell stack whose operational output indicator is the lowest of all the fuel cell stacks 103, 105, 107 of the fuel cell system 100, i.e. the first fuel cell stack 103, and switches it to a predetermined operating range which lies between a minimum output and a full output of the first fuel cell stack 103.

In the event that an output provided by the first fuel cell stack 103 is less than the output requirement, the monitoring device 109 selects a further fuel cell stack from the remaining fuel cell stacks 105 and 107 for activation. For this purpose, the monitoring device 109 again compares the service life indicators of the fuel cell stacks 105 and 107 and switches the fuel cell stack with the lowest service life indicator, i.e. the second fuel cell stack 105, to the specified operating range.

FIG. 2 shows a diagram 200 that spans an output in [KW] on its ordinate.

Diagram 200 shows three operating ranges, a first operating range 201 at minimum output, a second operating range 203 and a third operating range 205 at full output.

In the first operating range 201, a very high cell voltage of 900 millivolts, for example, results in a high load with correspondingly strong ageing of a fuel cell stack. Operation in this area should be prevented at all costs.

In the second operating range 203, the fuel cell stack is minimally loaded with a cell voltage between 725 millivolts and 850 millivolts and shows correspondingly minimal ageing.

In the third operating range 205, for example, the fuel cell stack is subjected to a medium to heavy load with a cell voltage between 600 millivolts and 725 millivolts and shows medium to heavy ageing.

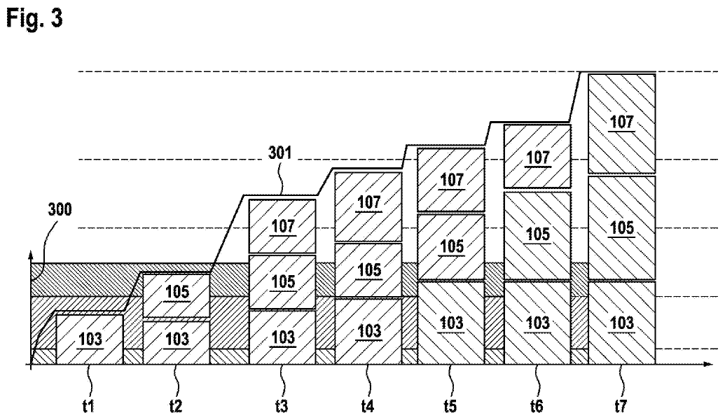

FIG. 3 shows a diagram 300 with the time in [s] on the abscissa and the output in [KW] on the ordinate.

Diagram 300 shows an operating diagram of the fuel cell system 100 according to FIG. 1.

A course 301 corresponds to an output requirement. At a first point in time t1, only the first fuel cell stack 103 is switched to the specified operating range, as this has the lowest service life indicator.

At a second point in time t2, the output requirement is increased so that the first fuel cell stack 103 can no longer meet the output requirement on its own without being switched to the range 205. Accordingly, the second fuel cell stack 105 is switched to the specified operating range, as it has a lower service life indicator than the third fuel cell stack 107.

At a third point in time t3, the output requirement is further increased so that the third fuel cell stack 107 is switched to the predetermined operating range in order to serve the output requirement.

At a fourth point in time t4, the output requirement is further increased so that the first fuel cell stack 103, the second fuel cell stack 105 and the third fuel cell stack 107 are subjected to an increased load within the predetermined operating range in order to serve the output requirement.

At a fifth point in time t5, the output requirement is further increased so that it can no longer be met by operating the first fuel cell stack 103, the second fuel cell stack 105 and the third fuel cell stack 107 within the predetermined operating range 203. In order to still meet the output requirement, the fuel cell stack with the lowest service life indicator, i.e. the first fuel cell stack 103, is switched to an increased operating range 205.

At a sixth point in time t6, the output requirement is further increased so that the fuel cell stack whose service life indicator is the lowest among the fuel cell stacks operated in the predetermined operating range, i.e. the second fuel cell stack 105, is switched to the increased operating range 205 in order to serve the output requirement.

At a seventh point in time t7, the output requirement is further increased so that the third fuel cell stack 107 is also switched to the increased operating range 205 in order to serve the output requirement.

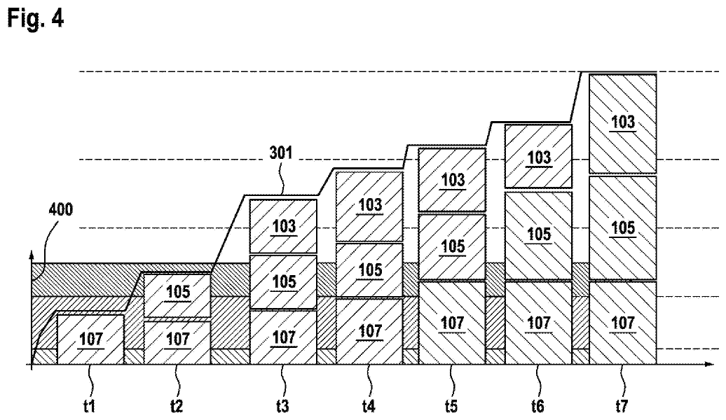

FIG. 4 shows a diagram 400 with the time in [s] on the abscissa and the output in [KW] on the ordinate.

Diagram 400 shows a further operating diagram of the fuel cell system 100 according to FIG. 1, which runs later than the operating diagram in FIG. 3. Accordingly, the first fuel cell stack 103 has a higher service life indicator than the second fuel cell stack 105 and the second fuel cell stack 105 has a higher service life indicator than the third fuel cell stack 107 due to the operation according to FIG. 3.

At a first point in time t1, only the third fuel cell stack 107 is switched to the predetermined operating range 203, as this has the lowest service life indicator.

At a second point in time t2, the output requirement is increased so that the third fuel cell stack 107 can no longer meet the output requirement within the operating range 203. Accordingly, the second fuel cell stack 105 is switched to the predetermined operating range 203, since it has a lower service life indicator than the first fuel cell stack 103.

At a third point in time t3, the output requirement is further increased so that the first fuel cell stack 103 is switched to the predetermined operating range 203 in order to serve the output requirement.

At a fourth point in time t4, the output requirement is further increased so that the third fuel cell stack 107, the second fuel cell stack 105 and the first fuel cell stack 103 are loaded at an increased rate within the predetermined operating range in order to serve the output requirement.

At a fifth point in time t5, the output requirement is further increased so that it can no longer be met by operating the third fuel cell stack 107, the second fuel cell stack 105 and the first fuel cell stack 103 within the specified operating range. In order to still meet the output requirement, the fuel cell stack with the lowest service life indicator, i.e. the third fuel cell stack 107, is switched to an increased operating range 205.

At a sixth point in time t6, the output requirement is further increased so that the fuel cell stack whose service life indicator is the lowest among the fuel cell stacks operated in the predetermined operating range, i.e. the second fuel cell stack 105, is switched to the increased operating range 205 in order to serve the output requirement.

At a seventh point in time t7, the output requirement is further increased so that the first fuel cell stack 103 is also switched to the increased operating range 205 in order to serve the output requirement.

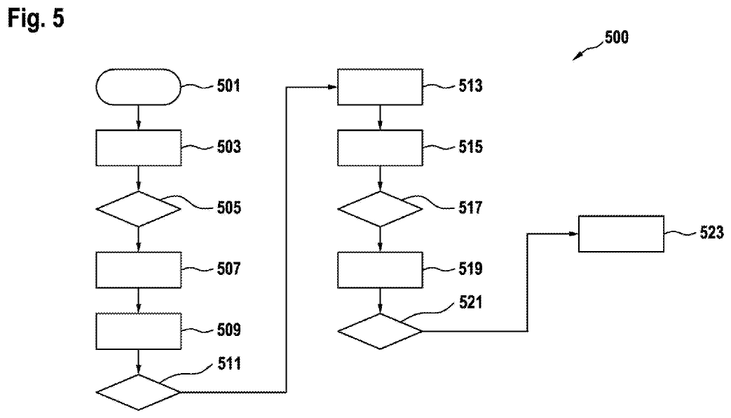

FIG. 5 shows an operating method 500.

Based on an increasing output requirement 501, the fuel cell stack whose service life indicator is the lowest is selected from a plurality of fuel cell stacks in a selection step 503.

Subsequently, a testing step 505 determines whether the output requirement is higher than an output that can be provided by the fuel cell stack selected in the selection step 503 in a predetermined operating range. If this is the case, the fuel cell stack with the second lowest service life indicator of the plurality of fuel cell stacks in the specified operating range is switched in a switching step 507.

Accordingly, in operating step 509, both selected fuel cell stacks are operated in the specified operating range.

In a further testing step 511, it is determined whether the output requirement is higher than an output that can be provided in the operating step 509. If this is the case, the fuel cell stack with the third lowest service life indicator in the specified operating range is switched in a further switching step 513. Accordingly, all fuel cell stacks are operated in the specified operating range in operating step 515.

In a further testing step 517, it is determined whether the output requirement is higher than an output that can be provided in the operating step 515. If this is the case, the fuel cell stacks with the lowest service life indicators are successively switched to an increased operating range in an amplification step 519.

In a further testing step 521, it is determined whether the output requirement is higher than an output that can be provided in the amplification step 519. If this is the case, a maximum output is set in a derating step 523, which is not increased any further.

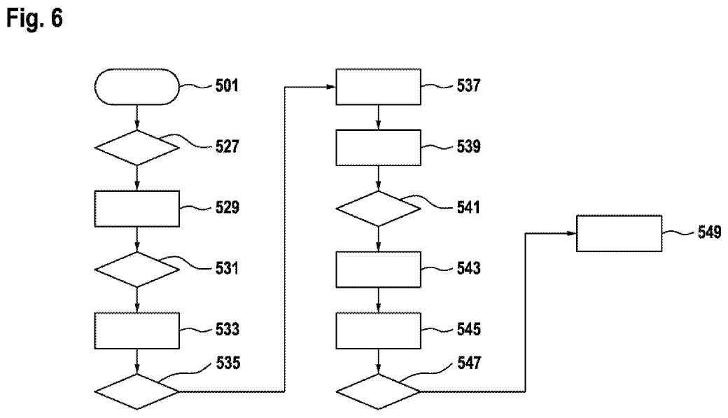

FIG. 6 shows a further course of the operating method 500.

Based on a decreasing output requirement 525, a testing step 527 determines whether the output requirement is less than the maximum output currently provided. If this is the case, the fuel cell stack with the highest service life indicator is switched to the specified operating range in a reduction step 529.

In a further testing step 531, it is determined whether the output requirement is less than an output that can be provided by all activated fuel cell stacks in the specified operating range. If this is the case, all fuel cell stacks are switched to the specified operating range in a reduction step 533.

In a further testing step 535, it is determined whether the output requirement is less than an output that can be provided by two fuel cell stacks in the specified operating range. If this is the case, the fuel cell stack with the highest service life indicator is switched off in a deactivation step 537.

In an operating step 539, those fuel cell stacks with the lowest operating hours are operated in the specified operating range.

In a further testing step 541, it is determined whether the output requirement is less than an output that can be provided in operating step 539. If this is the case, the fuel cell stack with the second-highest service life indicator is switched off in a deactivation step 543.

In an operating step 545, the fuel cell stack with the lowest service life indicator is operated in the predetermined operating range.

In a further testing step 547, it is determined whether the output requirement is greater than a minimum output of the fuel cell stack operated in the operating step 545. If this is the case, the last active fuel cell stack is also deactivated in a deactivation step 549.

1. A fuel cell system (100) for providing electrical energy,
wherein the fuel cell system (100) comprises:
a plurality of fuel cell stacks (103, 105, 107) comprising a first fuel cell stack (103) and at least one further fuel cell stack (105, 107),
a monitoring device (109) for monitoring the plurality of fuel cell stacks (103, 105, 107),
wherein the monitoring device (109) is configured to select, in response to an output requirement, that fuel cell stack (103, 105, 107) of the plurality of fuel cell stacks (103, 105, 107) for providing electric power whose service life indicator is the lowest among respective service life indicators of respective fuel cell stacks (103, 105, 107) of the plurality of fuel cell stacks (103, 105, 107), and
wherein the monitoring device (109) is further configured to operate the selected fuel cell stack (103, 105, 107) in a predetermined operating range and in the event that the output requirement cannot be met with the predetermined operating range of the selected fuel cell stack (103, 105, 107), to operate at least one further fuel cell stack (103, 105, 107) of the plurality of fuel cell stacks (103, 105, 107) in the predetermined operating range, wherein the predetermined operating range lies between a minimum output and a full output of the respective fuel cell stack (103, 105, 107).

2. The fuel cell system (100) according to claim 1,
wherein
the specified operating range of a cell voltage
corresponds to between 900 millivolts and 600 millivolts.

3. The fuel cell stack (100) according to claim 1,
wherein
in the event that the output requirement cannot be met with the predetermined operating range of the selected fuel cell stack (103, 105, 107), the monitoring device (109) is configured to switch, in addition to the selected fuel cell stack (103, 105, 107), that fuel cell stack (103, 105, 107) of the plurality of fuel cell stacks (103, 105, 107) into the predetermined operating range whose service life indicator is the lowest among respective service life indicators of respective further fuel cell stacks (103, 105, 107) of the plurality of fuel cell stacks (103, 105, 107).

4. The fuel cell system (100) according to claim 1,
wherein
in the event that the output requirement is reduced such that it is to be met with less than a number of fuel cell stacks (103, 105, 107) currently operated in the predetermined operating range, the monitoring device (109) is configured to deactivate that fuel cell stack (103, 105, 107) whose service life indicator is the highest among the activated fuel cell stacks (103, 105, 107).

5. The fuel cell system (100) according to claim 1,
wherein
a value from the following list of values is selected as the service life indicator: operational performance, operating time, maintenance interval, wear condition.

6. The fuel cell system (100) according to claim 1,
wherein
in the event that the output requirement cannot be met by operating all the fuel cell stacks of the plurality of fuel cell stacks (103, 105, 107) in the predetermined operating range, the monitoring device (109) is configured to switch the fuel cell stack (103, 105, 107) whose service life indicator is the lowest to an increased output range.

7. The fuel cell system (100) according to claim 6,
wherein
in the event that the output requirement cannot be met by operating all the fuel cell stacks (103, 105, 107) of the plurality of fuel cell stacks (103, 105, 107) in the predetermined operating range, the monitoring device (109) is configured to switch at least some of the respectively activated fuel cell stacks (103, 105, 107) for a predetermined duration into an overload operating range in which more output is generated than in the predetermined operating range, and only after the predetermined duration to switch that fuel cell stack (103, 105, 107) into an increased output range whose service life indicator is lowest.

8. An operating method (500) for operating a fuel cell system (100) having a plurality of fuel cell stacks (103, 105, 107),
wherein the operating method (500) comprises:
selecting, via a monitoring device, a respective fuel cell stack (103, 105, 107) to be operated in a predetermined operating range from the plurality of fuel cell stacks (103, 105, 107) in response to an output requirement, wherein the fuel cell stack (103, 105, 107) whose service life indicator is the lowest among respective service life indicators of respective fuel cell stacks (103, 105, 107) of the plurality of fuel cell stacks (103, 105, 107) is selected,
setting the selected fuel cell stack (103, 105, 107) to the predetermined operating range, and
expanding the selected fuel cell stack (103, 105, 107) by at least one further fuel cell stack (103, 105, 107) from the plurality of fuel cell stacks (103, 105, 107) in the event that an output provided by the selected fuel cell stack (103, 105, 107) in the predetermined operating range does not fulfill the output requirement, wherein the fuel cell stack (103, 105, 107) whose service life indicator is the lowest among respective service life indicators of respective fuel cell stacks (103, 105, 107) of the further fuel cell stacks is selected for expansion from among the further fuel cell stacks (103, 105, 107).

9. The operating method (500) according to claim 8,
wherein
the operating method comprises, in the event that the output requirement is reduced such that it is to be met with less than a number of fuel cell stacks (103, 105, 107) currently operating in the predetermined operating range, deactivating the fuel cell stack (103, 105, 107) whose service life indicator is highest among the activated fuel cell stacks (103, 105, 107).

10. A transportation means (101) comprising a fuel cell system (100) according to claim 1.
